(19) United States
(12) Patent Application Publication
(10) Pub. No.: US 2013/0286024 A1
(43) Pub. Date: Oct. 31, 2013

(54) FONT SIZE ADJUSTMENT METHOD AND ELECTRONIC DEVICE HAVING FONT SIZE ADJUSTMENT FUNCTION

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: REN-WEN HUANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/862,518

(22) Filed: Apr. 15, 2013

(30) Foreign Application Priority Data
Apr. 26, 2012 (CN) 201210125618.1

(51) Int. Cl. G06T 3/40

(52) U.S. Cl. CPC G06T 3/40
USPC 345/472.2

(57) ABSTRACT

A computerized font size adjustment method of an electronic device, the electronic device includes an image capturing device. Images of a user are captured using the image capturing device at intervals. A smallest rectangle framing an eye portion of a current image of the user and a ratio of a length to a width of the smallest rectangle are calculated. Then the ratio is compared with a predetermined value range, and the font size of the electronic device is adjusted according to the comparison.

### BACKGROUND

1. Technical Field

Embodiments of the present disclosure relate to electronic devices, and particularly to a font size adjustment method of an electronic device.

2. Description of Related Art

Many people like to read news and novels on the internet using electronic devices (e.g., mobile phones, portable computers, and mobile internet devices). Visually impaired users require a larger font size, if the font size setting of an electronic device is not appropriate, they may need to get very close to the electronic device to see the texts displayed on a screen of the electronic device, which may be harmful to the vision of the users. In addition, the font size of the electronic device may be manually adjusted to achieve a good viewing experience. However, this method may take the user several tries to get satisfactory viewing, which is time consuming and inconvenient. Therefore, there is room for improvement in the art.

### BRIEF DESCRIPTION OF THE DRAWINGS

FIG. 1 is a schematic block diagram illustrating one embodiment of an electronic device.

FIG. 2 is a schematic diagram of a reference image having a facial image.

FIG. 3 shows a flowchart of one embodiment of a font size adjustment method using a font size adjustment system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

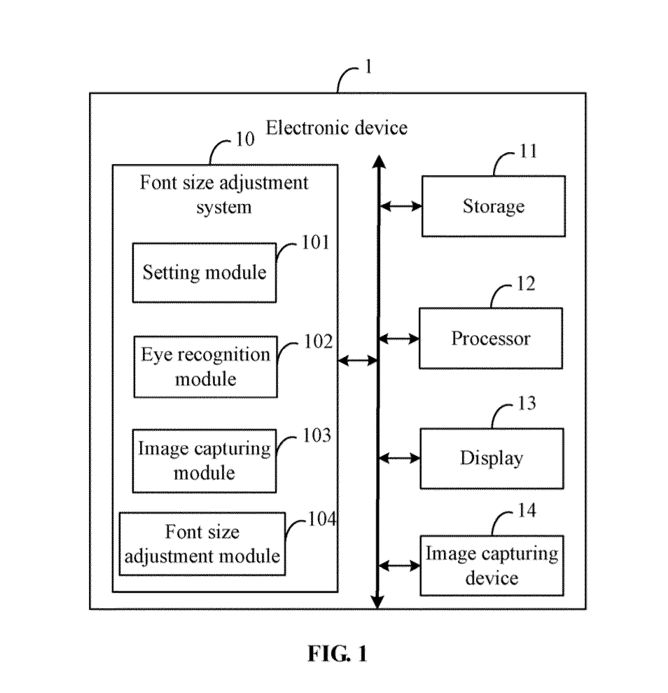

FIG. 1 shows a schematic block diagram illustrating one embodiment of an electronic device 1. In the embodiment, the electronic device 1 may be, for example, a smart phone, a personal digital assistant (PDA), a mobile internet device (MID), or a portable computer. The electronic device 1 includes a font size adjustment system 10, a storage 11, a processor 12, a display 13, and an image capturing device 14. The font size adjustment system 10 is configured for adjusting the font size of the electronic device 1, details are provided below. The font size adjustment system 10 may include a plurality of programs in the form of one or more computerized instructions stored in the storage 11 and executed by the processor 12 to perform operations of the electronic device 1. In the embodiment, the font size adjustment system 10 includes a setting module 101, an eye recognition module 102, an image capturing module 103, and a font size adjustment module 104.

In general, the word “module,” as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

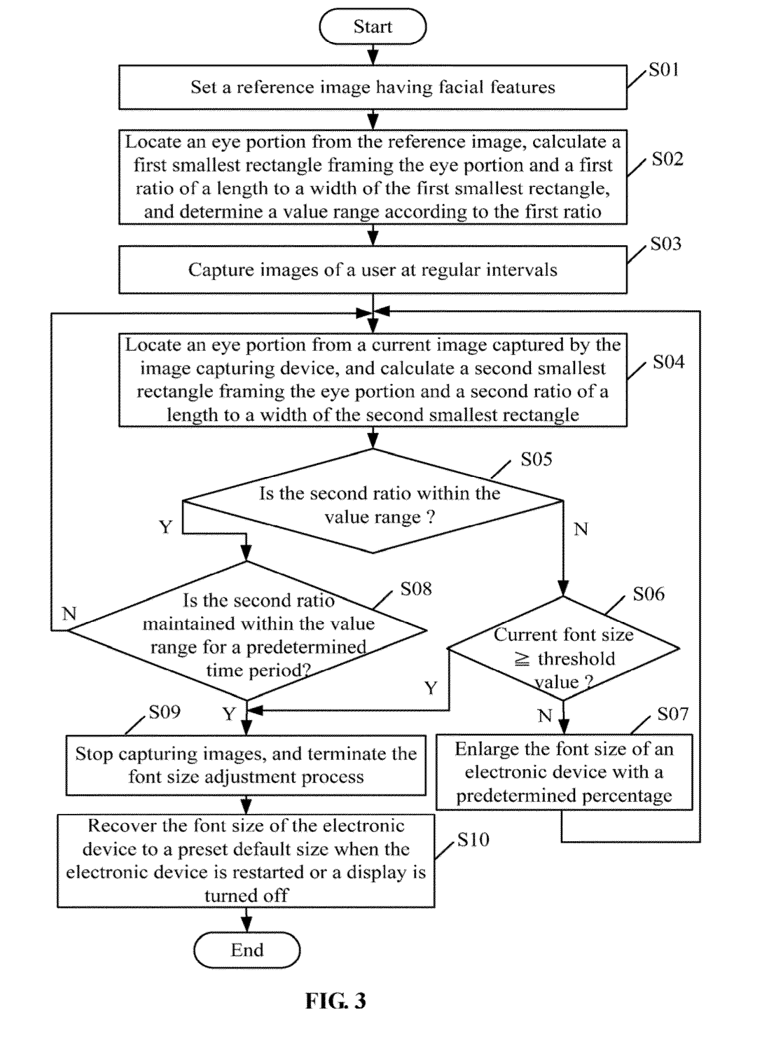

FIG. 3 shows a flowchart of one embodiment of a method for adjusting the font size of the electronic device using the font size adjustment system 10 of FIG. 1. Depending on the embodiment, additional steps may be added, others removed, and the ordering of the steps may be changed.

In step S01 the setting module 101 sets a reference image having facial features of the user. The reference image may be pre-captured by the user using the image capturing device 14 when the user views the display 13 at an appropriate distance from the display 13. At this viewing distance, the user may have a clear view of the texts displayed on the display 13.

In step S02, the eye recognition module 102 locates an eye portion from the reference image, calculates a first smallest rectangle framing the eye portion of the reference image and a first ratio of a length to a width of the first smallest rectangle, and determines a value range according to the calculated first ratio. For example, if the calculated first ratio is R, the value range may be [R−2%, R+2%].

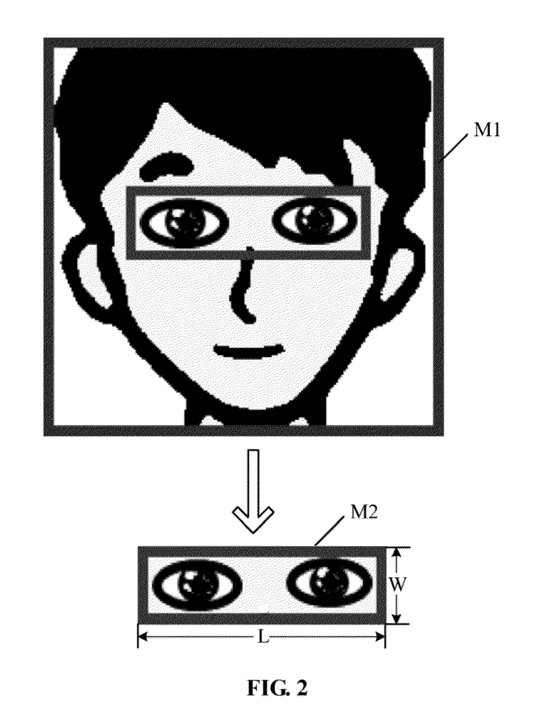

In the embodiment, the eye recognition module 102 may locate the eye portion from the reference image using a template matching method, a neural network training method, or other known eye recognition technologies. In one example, a reference image M1 is shown in FIG. 2. An eye portion is located from the reference image M1, and then the eye portion is framed in a rectangle M2. The rectangle M2 is defined to be the first smallest rectangle framing the eye portion. Thereupon, the eye recognition module 102 calculates a ratio R of a length L to a width W of the rectangle M2, and determines the value range according to the ratio R of L to W. The calculated ratio R and the determined value range are stored in the storage 11.

In step S03, the image capturing module 103 controls the image capturing device 14 to capture images of a user in front of the display 13 at regular intervals, such as every two or three seconds.

In step S04, the eye recognition module 102 locates an eye portion from a current image captured by the image capturing device 14, and calculates a second smallest rectangle framing the eye portion of the current image and a second ratio of a length to a width of the second smallest rectangle.

In step S05, the font size adjustment module 104 determines whether the second ratio is within the value range. If the second ratio is within the second value range, the procedure goes to step S08. Otherwise, if the second ration is outside of the value range, the procedure goes to step S06.

In step S06, the font size adjustment module 104 determines whether a current font size of the electronic device 1 is greater than or equal to a predetermined threshold value, if yes, the procedure goes to step S09. If the current font size of the electronic device 1 is less than the predetermined threshold value, the procedure goes to step S07. In the embodiment, the threshold value may be the maximum font size supported by the electronic device 1.

In step S07, the font size adjustment module 104 enlarges the font size of the electronic device 1 with a predetermined percentage (e.g., 10%), the procedure goes back to step S04.

In step S08, the font size adjustment module 104 determines whether the calculated second ratio using the current image captured by the image capturing device 14 is maintained within the value range for a predetermined time period (e.g., three or five seconds). If the calculated second ratio using the current image captured by the image capturing device 14 has been maintained within the value range for the predetermined time period, the procedure goes to step S09. Otherwise, the procedure goes back to step S04.

In step S09, the font size adjustment module 104 controls the image capturing device 14 to stop capturing images, and terminates the font size adjustment process of the electronic device 1.

In step S10, when the electronic device 1 is restarted or the display 13 is powered/turned off, the font size adjustment modules 104 recovers the font size of the electronic device 1 to a preset default size.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized font size adjustment method of an electronic device having an image capturing device, the method comprising:
setting a reference image having facial features;
locating an eye portion from the reference image;
calculating a first smallest rectangle framing the eye portion of the reference image and a first ratio of a length to a width of the first smallest rectangle;
determining a value range according to the first ratio;
capturing images of a user using the image capturing device;
locating an eye portion from a current image of the user captured by the image capturing device;
calculating a second smallest rectangle framing the eye portion of the current image and a second ratio of a length to a width of the second smallest rectangle;
determining whether the second ratio is within the value range and whether a current font size of the electronic device is greater than or equal to a predetermined threshold value; and
enlarging the font size of the electronic device with a predetermined percentage, when the second ratio is outside of the value range and the current font size of the electronic device is less than the predetermined threshold value.

2. The method according to claim 1, further comprising:
controlling the image capturing device to stop capturing images and terminating the font size adjustment process of the electronic device, when the second ratio is maintained within the value range for a predetermined time period.

3. The method according to claim 1, further comprising:
controlling the image capturing device to stop capturing images and terminating the font size adjustment process of the electronic device, when the second ratio is greater than or equal to the predetermined threshold value.

4. The method according to claim 1, further comprising:
recovering the font size of the electronic device to a preset default size, when the electronic device is restarted or a display of the electronic device is turned off.

5. The method according to claim 1, wherein the image capturing device captures the images of the user at regular intervals.

6. The method according to claim 1, wherein the predetermined threshold value is a maximum font size supported by the electronic device.

7. The method according to claim 1, wherein the value range is [R−2%, R+2%], where R represents the first ratio.

8. The method according to claim 1, wherein the reference image is pre-captured using the image capturing device when the user views a display of the electronic device at an appropriate distance from the display.

9. An electronic device, comprising:
a storage;
a processor;
an image capturing device; and
one or more programs stored in the storage and executed by the processor, the one or more programs comprising:
a setting module setting a reference image having facial features;
an eye recognition module locating an eye portion from the reference image, calculating a first smallest rectangle framing the eye portion of the reference image and a first ratio of a length to a width of the first smallest rectangle, and determining a value range according to the first ratio;
an image capturing module controlling the image capturing device to capture images of a user;
the eye recognition module further locating an eye portion from a current image captured by the image capturing device, and calculating a second smallest rectangle framing the eye portion of the current image and a second ratio of a length to a width of the second smallest rectangle; and
a font size adjustment module determining whether the second ratio is within the value range and whether a current font size of the electronic device is greater than or equal to a predetermined threshold value, and enlarging the font size of the electronic device with a predetermined percentage when the second ratio is outside of the value range and the current font size of the electronic device is less than the predetermined threshold value.

10. The electronic device according to claim 9, wherein the font size adjustment module further controls the image capturing device to stop capturing images and terminates the font size adjustment process of the electronic device, when the second ratio is maintained within the value range for a predetermined time period.

11. The electronic device according to claim 9, wherein the font size adjustment module further controls the image capturing device to stop capturing images and terminating the font size adjustment process of the electronic device, when the second ratio is greater than or equal to the predetermined threshold value.

12. The electronic device according to claim 9, wherein the font size adjustment module further recovers the font size of the electronic device to a preset default size, when the electronic device is restarted or a display of the electronic device is turned off.

13. The electronic device according to claim 9, wherein the image capturing module controls the image capturing device to capture the images of the user at regular intervals.

14. The electronic device according to claim 9, wherein the predetermined threshold value is a maximum font size supported by the electronic device.

15. The electronic device according to claim 9, wherein the value range is [R−2%, R+2%], where R represents the first ratio.

16. The electronic device according to claim 9, wherein the reference image is pre-captured using the image capturing device when the user views a display of the electronic device at an appropriate distance from the display.
